(19) United States
(12) Patent Application Publication
(10) Pub. No.: US 2023/0129836 A1
(43) Pub. Date: Apr. 27, 2023

(54) WAFER PADLOCK

(71) Applicant: ABA LOCKS INTERNATIONAL CO., LTD., New Taipei City (TW)

(72) Inventor: Miko LEE, New Taipei City (TW)

(73) Assignee: ABA LOCKS INTERNATIONAL CO., LTD., New Taipei City (TW)

(21) Appl. No.: 17/508,351

(22) Filed: Oct. 22, 2021

(51) Int. Cl. E05B 67/14; E05B 67/22

(52) U.S. Cl. CPC E05B 67/14; E05B 67/22

(57) ABSTRACT

A wafer padlock has a lock body, a limiting wafer, multiple locking wafers, and a shackle. The limiting wafer and the locking wafers are arranged in the lock body at spaced intervals. One of two ends of the shackle is selectively engaged with the lock body, and the other one of the two ends of the shackle is inserted in the lock body and extends through the limiting wafer and the locking wafers. The wafer padlock is unlocked by inserting a key into at least one key hole formed in the lock body. There is no need to turn the key and no need to enter code numbers one by one. Unlocking of the wafer padlock is quick and convenient. The wafer padlock has simple structures and high security for locking items.

### BACKGROUND OF THE INVENTION

### 1. Field of the Invention

The present invention relates to a padlock, and more particularly to a wafer padlock that has simple structures and high security.

### 2. Description of the Prior Art

A padlock is one of common small lock devices and is adapted to simply lock an item, e.g. a bicycle, a cabinet, luggage, and so on. Conventional padlocks, which are distinguished by unlocking methods, include combination padlocks unlocked by entering codes, tubular padlocks unlocked by tubular keys, and wafer tumbler padlocks unlocked by flat keys.

Although the conventional padlocks are suitable for simple locking, to unlock the above mentioned combination padlock, preset code numbers need to be entered one by one, to unlock the above mentioned tubular padlock or wafer tumbler padlock, after the tubular keys or the flat keys are inserted therein, the tubular keys or the flat keys need to be turned to unlock the tubular padlocks or the wafer tumbler padlocks. Accordingly, unlocking of the conventional padlocks is not quick and convenient enough. Especially, when a user carrying a suitcase with a conventional padlock goes through airport customs, custom officers may ask the user to open the suitcase for a security check. At this time, to unlock the conventional padlock by entering correct code numbers or inserting and turning a key, the user may not be able to successfully unlock the conventional padlock under tension. In summary, the conventional padlock needs to be improved.

To overcome the shortcomings, the present invention provides a wafer padlock to mitigate or obviate the aforementioned problems.

### SUMMARY OF THE INVENTION

The main objective of the present invention is to provide a wafer padlock that can be quickly and conveniently unlocked and is secure in use.

To achieve the foregoing purpose, the wafer padlock comprises a lock body, a limiting wafer, multiple locking wafers, and a shackle. The lock body has an engaging channel recessed in and formed in a top of the lock body from an external surface of the lock body, a latching channel recessed in and formed in the top of the lock body and extending longitudinally toward a bottom of the lock body, multiple wafer grooves formed in the lock body and arranged along a longitudinal direction at spaced intervals and located between the top and the bottom of the lock body, each of the wafer grooves has two opposite ends extending toward two opposite sides of the lock body respectively and communicating with the latching channel via one of the two opposite ends of the wafer groove, and at least one key hole formed in the lock body and communicating with the wafer grooves.

The limiting wafer is disposed in one of the wafer grooves that is closest to the top of the lock body and has a limiting hole formed through the limiting wafer and located in the latching channel. The locking wafers are respectively disposed in the other ones of the wafer grooves and are transversally slidable along the corresponding wafer grooves. Each of the locking wafers has a locking hole formed through the locking wafer. Multiple restoring elastic members are respectively disposed between the locking wafers and the lock body. Each of the restoring elastic members has two ends abutting against a corresponding one of the locking wafers and the lock body respectively.

The shackle has a bending segment and a latching segment. The bending segment is U-shaped and has two ends respectively defined as an engaging end and a connecting end, the engaging end selectively inserted into the engaging channel of the lock body. The latching segment extends from the connecting end of the bending segment, is inserted in the latching channel of the lock body, extends through the limiting hole of the limiting wafer and the locking holes of the locking wafers, and has multiple engaging flanges arranged along the latching segment at spaced intervals.

The limiting wafer is located between the connecting end of the bending segment and one of the engaging flanges that is closest to the connecting end of the bending segment. Each of the locking wafers is pushed by the corresponding one of the restoring elastic members to move a hole edge of the locking hole of the locking wafer partially inside the latching channel to engage with a respective one of the engaging flanges of the latching segment via the respective one of the engaging flanges abutting against a bottom surface of the locking wafer.

With the above mentioned arrangements, the latching wafers are pushed to transversally slide to move the hole edges of the locking holes of the locking wafers out from the latching channel and the locking wafers by a key inserted in the at least one key hole. Whereby, the latching wafers are disengaged from the engaging flanges of the lathing segment to unlock the wafer padlock. No need to further turn the key or enter code numbers one by one, unlocking of the wafer padlock is quick and convenient. In addition, the wafer padlock in accordance with the present invention has simple structures and high security for locking items.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a first embodiment of a wafer padlock in accordance with the present invention shown with a corresponding key;

FIG. 2 is an exploded perspective view in partial section of the first embodiment of the wafer padlock in FIG. 1;

FIG. 3 is a cross sectional side view of the first embodiment of the wafer padlock in FIG. 1 showing that the wafer padlock is locked;

FIG. 4 is an operational cross sectional side view of the first embodiment of the wafer padlock in FIG. 1 showing unlocking of the wafer padlock;

FIG. 5 is an operational perspective view of a second embodiment of a wafer padlock in accordance with the present invention shown with a corresponding key;

FIG. 6 is an exploded perspective view in partial section of the second embodiment of the wafer padlock in FIG. 5;

FIG. 7 is a cross sectional side view of the second embodiment of the wafer padlock in FIG. 5 showing that the wafer padlock is locked;

FIG. 8 is an operational cross sectional side view of the second embodiment of the wafer padlock in FIG. 1 showing unlocking of the wafer padlock;

FIG. 9 is an operational perspective view of a third embodiment of a wafer padlock in accordance with the present invention shown with a corresponding key;

FIG. 10 is a cross sectional side view of the third embodiment of the wafer padlock in FIG. 9 showing that the wafer padlock is locked;

FIG. 11 is an operational perspective view of a fourth embodiment of a wafer padlock in accordance with the present invention shown with a corresponding key; and

FIG. 12 is a cross sectional side view of the fourth embodiment of the wafer padlock in FIG. 11 showing that the wafer padlock is locked.

### DETAILED DESCRIPTION OF THE PREFERRED EMBODIMENTS

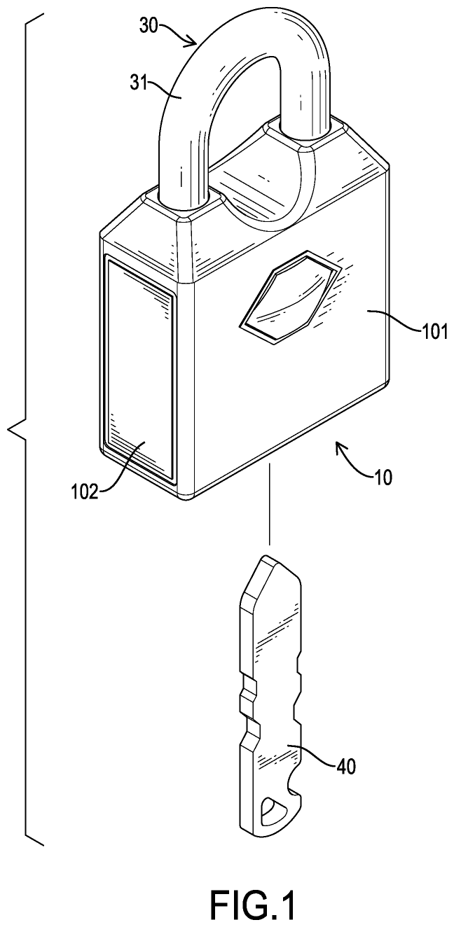

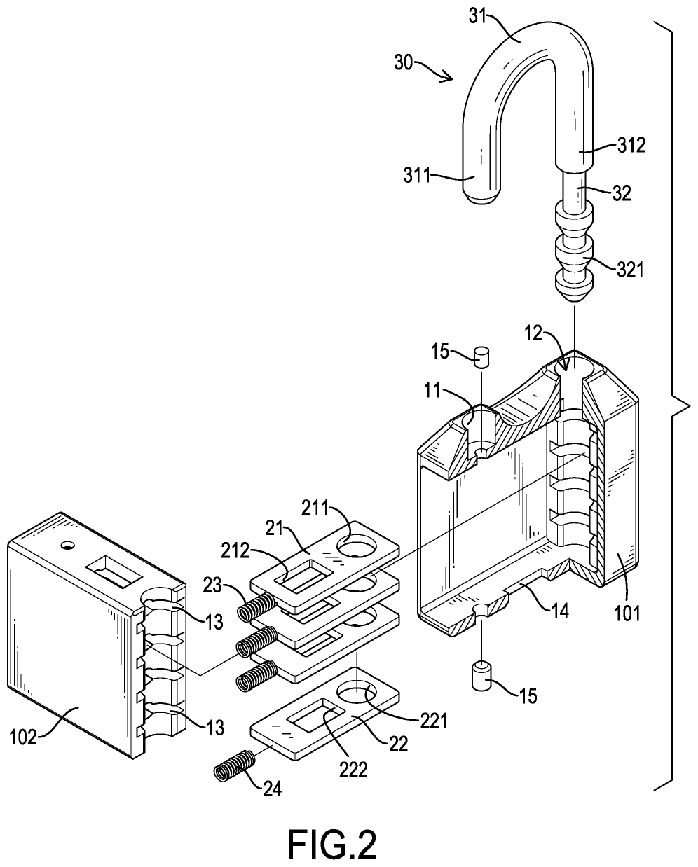

With reference to FIGS. 1 and 2, a first embodiment of a wafer padlock in accordance with the present invention comprises a lock body 10, a limiting wafer 21, multiple locking wafers 22, and a shackle 30.

The lock body 10 has a top, a bottom, and two sides. The two sides of the lock body 10 are formed between the top and the bottom of the lock body and are opposite to each other. The lock body 10 has an engaging channel 11, a latching channel 12, multiple wafer grooves 13, and at least one key hole 14. The engaging channel 11 is recessed in and formed in the top of the lock body 10 adjacent to one of the two sides thereof. The latching channel 12 is recessed in and formed in the top of the lock body 10 adjacent to the other one of the two sides thereof and longitudinally extends toward the bottom of the lock body 10. The wafer grooves 13 are formed in the lock body 10 and are arranged along a longitudinal direction at spaced intervals and are located between the top and the bottom of the lock body 10. Each of the wafer grooves 13 has two opposite ends extending toward the two sides of the lock body 10 respectively and communicates with the latching channel 12 via one of the two opposite ends thereof. The at least one key hole 14 is formed in the lock body 10 between the two sides and communicates with the wafer grooves 13.

In the first embodiment, the lock body 10 has a hollow lock housing 101 and a lock core 102. The lock core 102 is fixed in the lock housing 101. Two fixing pins 15 are mounted in the lock housing 101 and are engaged with the lock core 102 to fix the lock core 102 with the lock housing 101. In addition, the engaging channel 11 is recessed in the lock housing 101. The latching channel 12 is longitudinally formed in the lock housing 101 and is formed between an inner surface of the lock housing 101 and the lock core 102. The multiple wafer grooves 13 are formed in the lock core 102, are arranged at spaced intervals, and extend into the inner surface of the lock housing 101. The at least one key hole 14 is formed through the lock housing 101.

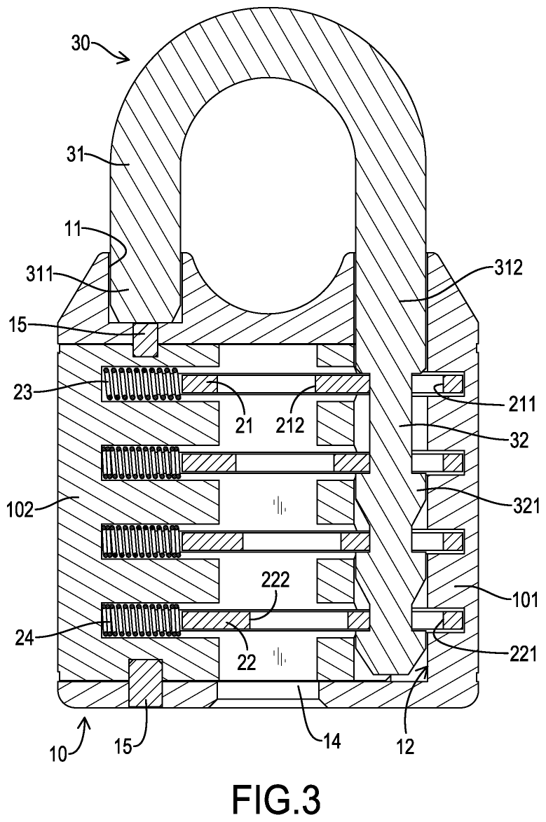

With reference to FIG. 3, the limiting wafer 21 is disposed in one of the wafer grooves 13 that is closest to the top of the lock body 10. Two opposite ends of the limiting wafer 21 are respectively defined as a first end and a second end. A limiting hole 211 is formed through the limiting wafer 21 near the first end and is located in the latching channel 12. A limiting elastic member 23 is disposed in the wafer groove 13 that is closet to the top of the lock body 10 and is disposed between the second end of the limiting wafer 21 and the lock body 10. Two ends of the limiting elastic member 23 respectively abut against the lock body 10 and the second end of the limiting wafer 21.

The multiple locking wafers 22 are respectively disposed in the other ones of the wafer grooves 13 and are transversally slidable along the corresponding wafer grooves 13. Each of the locking wafers 22 has two opposite ends respectively defined as a first end and a second end, a locking hole 221 formed through the locking wafer 22 and located near the first end thereof and located in the latching channel 12. Multiple restoring elastic members 24 are respectively disposed in the corresponding wafer grooves 13 and respectively disposed between the second ends of the locking wafers 22 and the lock body 10. Two ends of each of the restoring elastic members 24 respectively abut against the lock body 10 and the second end of a corresponding one of the locking wafers 22.

The shackle 30 has a bending segment 31 and a latching segment 32. The bending segment 31 is U-shaped and has two ends respectively defined as an engaging end 311 and a connecting end 312. The engaging end 311 is selectively inserted into the engaging channel 11 of the lock body 10.

The latching segment 32 extends downwardly from the connecting end 312 of the bending segment 31, is inserted in the latching channel 12 of the lock body 10, and extends through the limiting hole 211 of the limiting wafer 21 and the locking holes 221 of the multiple locking wafers 22. The latching segment 32 has multiple engaging flanges 321 arranged along the latching segment 32 at spaced intervals. Each of the engaging flanges 321 is inverted conical and has a cross-sectional area gradually decreasing downwardly. The limiting wafer 21 is located between the connecting end 312 of the bending segment 31 of the shackle 30 and one of the engaging flanges 321 that is closest to the connecting end 312 of the bending segment 31.

With reference to FIG. 3, when the wafer padlock is locked, the engaging end 311 extends into the engaging channel 11 of the lock body 10, and the limiting wafer 21 abuts against the connecting end 312 of the bending segment 31 of the shackle 30. Each of the locking wafers 22 is pushed by the corresponding one of the restoring elastic members 24 to move a hole edge of the locking hole 221 of the locking wafer 22 partially inside the latching channel 12 to engage with a respective one of the engaging flanges 321 via the respective one of the engaging flanges 321 of the latching segment 32 that abuts against a bottom surface of the locking wafer 22.

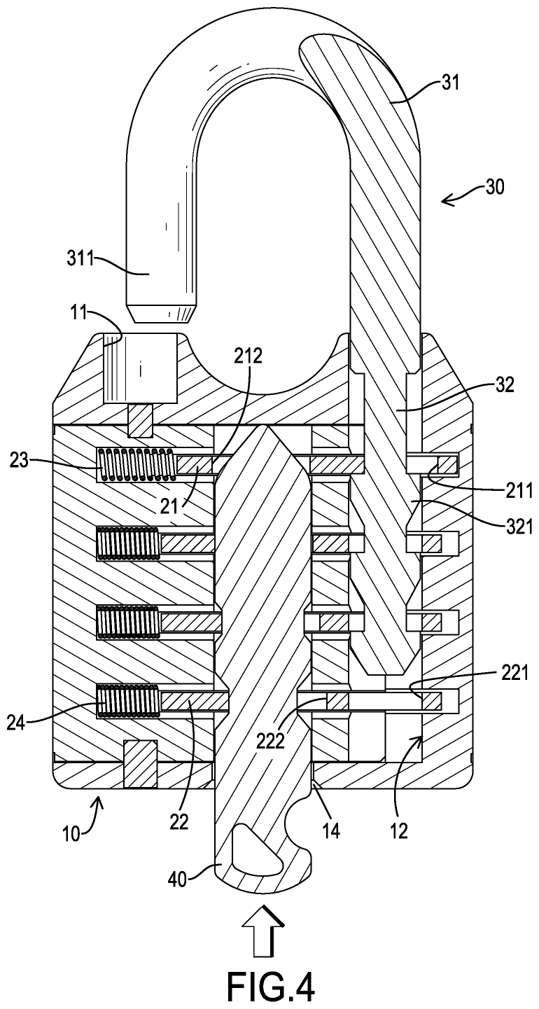

With reference to FIG. 4, when a key 40 is inserted in the at least one key hole 14 to unlock the wafer padlock of the present invention, the key 40 pushes the locking wafers 22 to transversally slide to compress the corresponding restoring elastic members 24. The hole edges of the locking holes 221 of the locking wafers 22 are moved out from the latching channel 12 of the lock body 10 and the locking wafers 22 are disengaged from the engaging flanges 321 of the latching segment 32. At this time, the engaging flanges 321 of the shackle 30 can respectively pass through the locking holes 221 of the corresponding locking wafers 22, whereby the shackle 30 can be pulled upwardly to detach the engaging end 311 of the bending segment 31 of the shackle 30 from the engaging channel 11 to unlock the wafer padlock. In addition, in the unlocked state, the limiting wafer 21 is still pushed by the limiting elastic member 23 to stay in the position. The engaging flange 321 that is closest to the top of the lock body 10 can be moved up to locate between the bottom surface of the limiting wafer 21 and the top surface of the corresponding locking wafer 22 and is blocked by the limiting wafer 21 to prevent the latching segment 32 from separating from the latching channel 12.

In addition, a compression spring can be disposed between a bottom of the latching segment 32 of the shackle 30 and the lock body 10. When the wafer padlock is locked, the compression spring is compressed by the latching segment 32 of the shackle 30. When the key 40 is inserted to push the locking wafers 22 to disengage from the engaging flanges 321 of the latching segment 32, the shackle 30 is pushed to move up to unlock the wafer padlock by elastic restoring force of the compression spring.

With reference to FIGS. 1 to 4, in the first embodiment of the wafer padlock of the present invention, the lock body 10 has one said key hole 14 formed in the bottom of the lock body 10 and longitudinally extending toward the top thereof. More particularly, the key hole 14 is formed through the lock housing 101 and extends into the lock core 102 of the lock body 10. The limiting wafer 21 has a through hole 212 formed therethrough and corresponding to the key hole 14 in position. Each of the locking wafers 22 has an unlocking hole 222 formed therethrough and corresponding to the key hole 14 in position. With reference to FIG. 3, in the locked state, the unlocking holes 222 of the locking wafer 22 are misaligned and are arranged non-coaxially. With reference to FIG. 4, to unlock the wafer padlock, the key 40 is inserted through the key hole 14 of the lock body 10 and the unlocking holes 222 of the locking wafers 22, and extends into the through hole 212 of the limiting wafer 21 to push the locking wafers 22 to transversally slide.

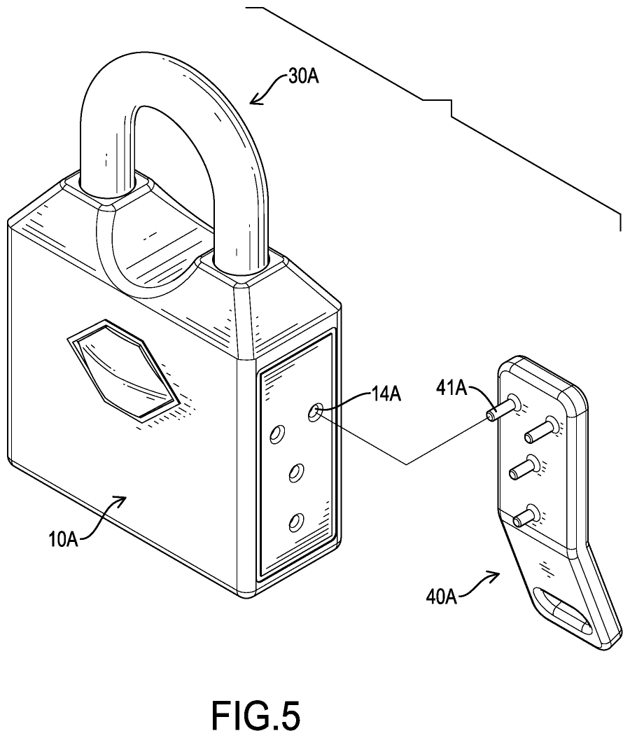

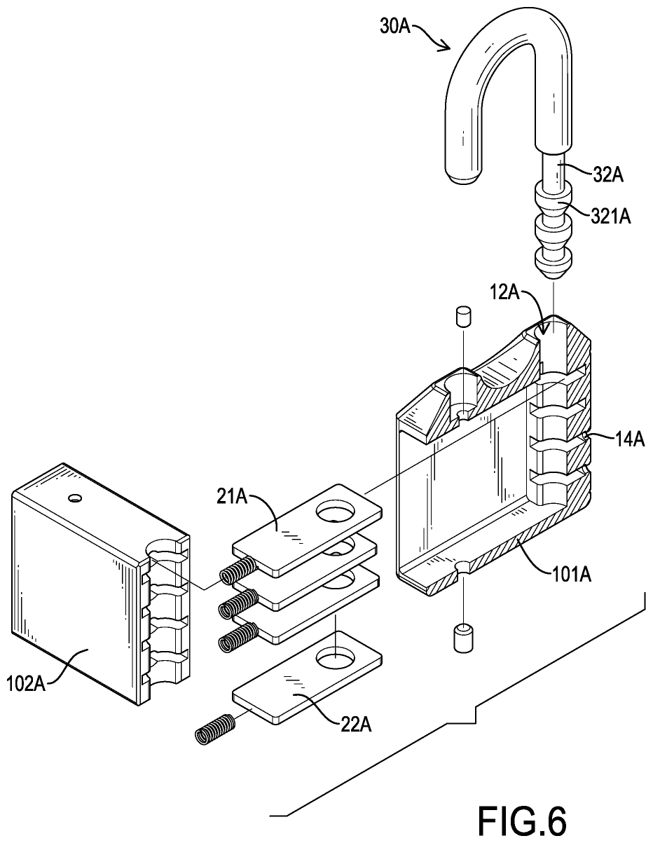

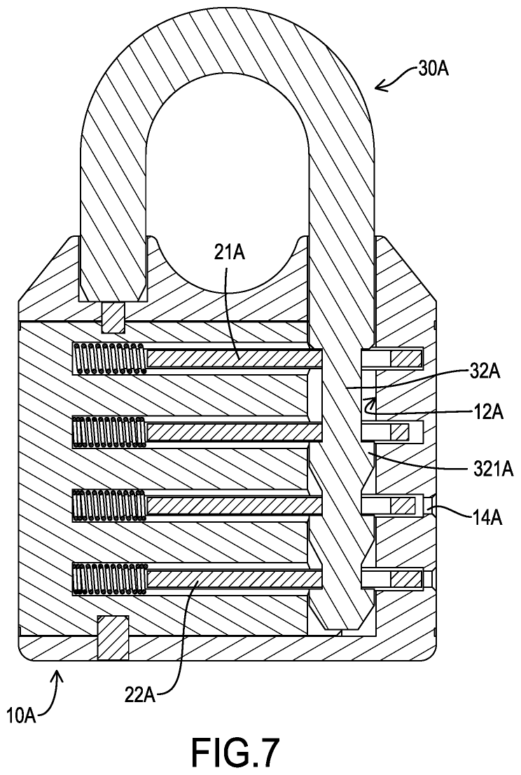

With reference to FIGS. 5 to 8, in the second embodiment of the wafer padlock in accordance with the present invention, the lock body 10A has a hollow lock housing 101A and a lock core 102A mounted in the lock housing 101A. The lock body 10A has multiple said key holes 14A formed in one of the two sides of the lock body 10A away from the restoring elastic members. Each of the said key holes 14A communicates with a respective one of the wafer grooves. The first end of the limiting wafer 21A and the first ends of the locking wafers 22A face the side of the lock body 10A where the key holes 14A are formed therein. The key holes 14A are respectively aligned with the first ends of the locking wafers 22A. Each of the locking wafers 22A may align with multiple of the said key holes 14A or single one of the said key holes 14A. A key 40A to unlock the second embodiment of the wafer padlock has multiple unlocking rods 41A. An arrangement of the unlocking rods 41A is same as an arrangement of the key holes 14A of the lock body 10A, such that the unlocking rods 41A can be respectively inserted in the key holes 14A at the same time.

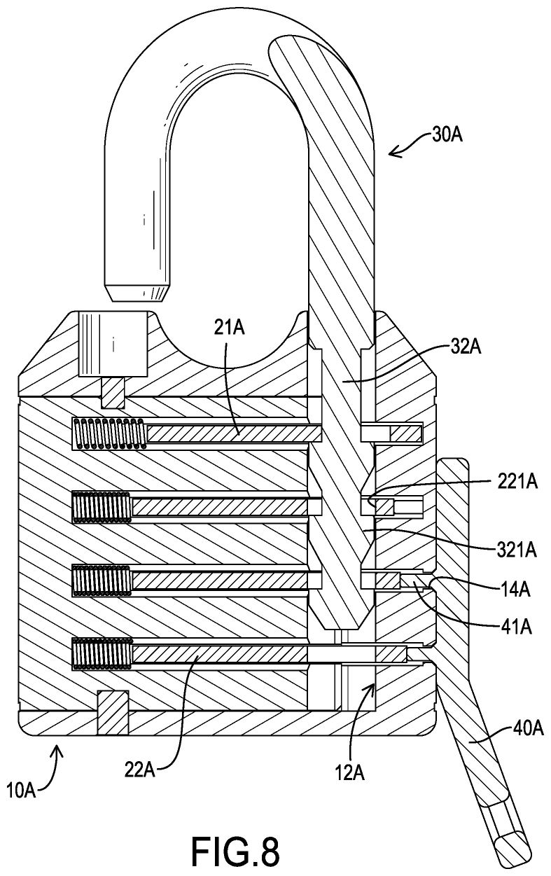

With reference to FIG. 8, when the unlocking rods 41A of the key 40A are respectively inserted in the key holes 14A to unlock the second embodiment of the wafer padlock, the unlocking rods 41A will push the locking wafers 22A from the first ends of the locking wafers 22A to move the hole edges of the locking wafers 22A out from the latching channel 12A. Whereby, the locking wafers 22A are respectively disengaged from the engaging flanges 321A of the latching segment 32A at the same time, and the shackle 30 can be moved up to unlock the wafer padlock.

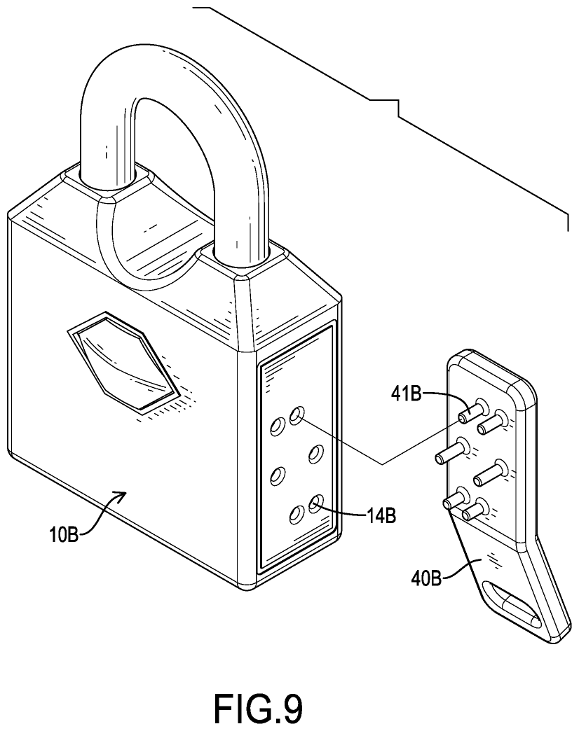

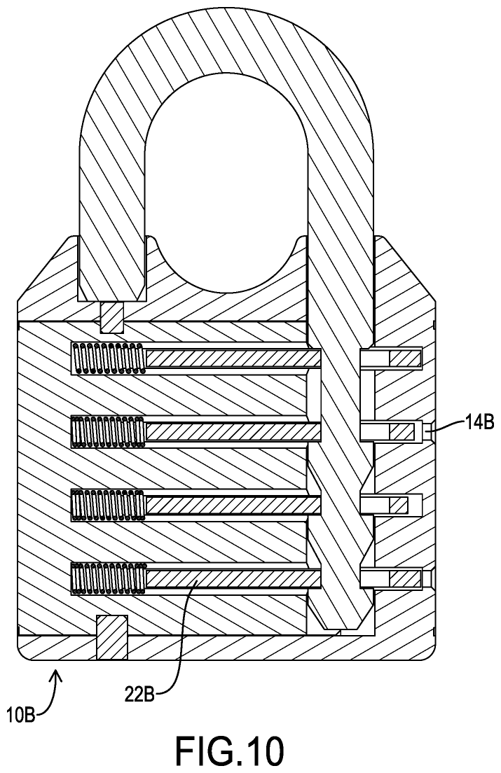

With reference to FIGS. 9 and 10, the third embodiment of the wafer padlock is substantially same as the second embodiment of the wafer padlock. The difference therebetween is the arrangement of the key holes 14B of the lock body 10B, wherein each of the locking wafers 22B is aligned with multiple of the key holes 14B. Correspondingly, an arrangement of multiple unlocking rods 41B of a key 40B for unlocking the third embodiment of the wafer padlock is same as the arrangement of the key holes 14B. So the unlocking rods 41B can be respectively inserted in the key holes 14B at the same time to unlock the wafer padlock.

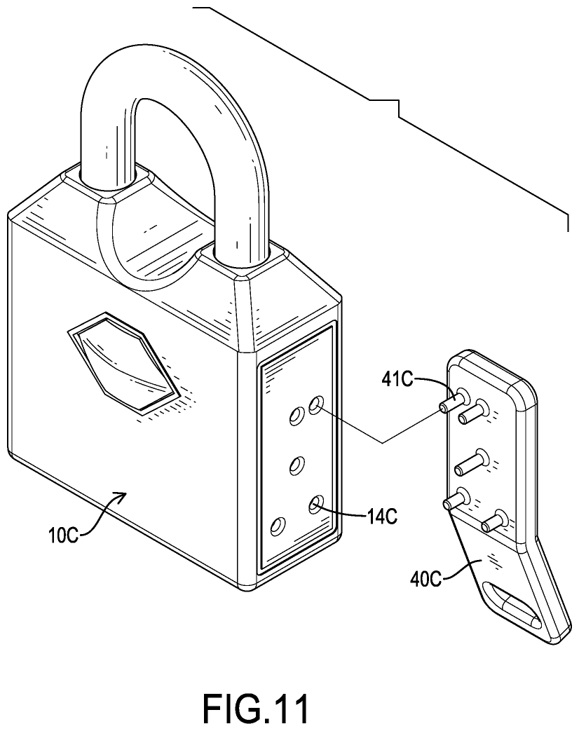

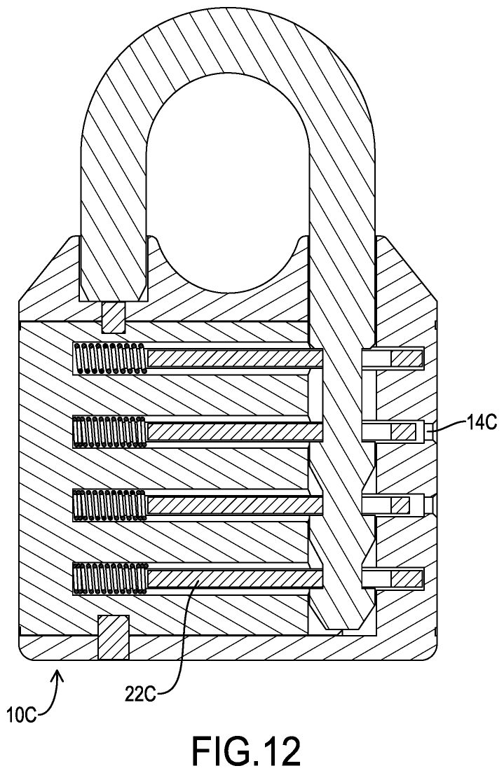

With reference to FIGS. 11 and 12, a fourth embodiment of the wafer padlock is substantially same as the second embodiment of the wafer padlock. The difference therebetween is the arrangement of the key holes 14C of the lock body 10C, wherein some of the locking wafers 22C are aligned with multiple of the key holes 14C, the other ones of the locking wafers 22C are aligned with single one of the key holes 14C. Correspondingly, an arrangement of multiple unlocking rods 41C of a key 40C for unlocking the fourth embodiment of the wafer padlock is same as the arrangement of the key holes 14C. So the unlocking rods 41C can be respectively inserted in the key holes 14C at the same time to unlock the wafer padlock.

With reference to FIGS. 5 to 12, in any one of the second to the fourth embodiments of the wafer padlocks in accordance with the present invention, each of the locking wafers 22A, 22B, 22C has one respective length from the first end to the second end thereof being different from one another. Correspondingly, the unlocking rods 41A, 41B, 41C of the key 40A, 40B, 40C corresponding to different locking wafers 22A, 22B, 22C have different lengths. The respective lengths of the locking wafers 22A, 22B, 22C and the arrangement of the key holes 14A, 14B, 14C of the key body 10A, 10B, 10C can be changed to change the wafer padlock being suitable for varying keys 40A, 40B, 40C.

With reference to FIGS. 3 and 4, in the first embodiment of the wafer padlock in accordance with the present invention, the unlocking holes 222 of the locking wafers 22 are not coaxially arranged, so the positions of the unlocking holes 222 of the locking wafers 22 relative to one another can be changed to change the wafer padlock for varying keys 40.

The wafer padlock in accordance with the present invention has the following advantages. The wafer padlock has simple structures and is secure for locking items. The wafer padlock is unlocked via inserting the key 40, 40A, 40B, 40C into the key holes 14, 14A, 14B, 14C of the lock body 10, 10A, 10B, 10C. No need to further turn the key 40, 40A, 40B, 40C or enter code numbers one by one, unlocking of the wafer padlock is quick and convenient.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wafer padlock comprising:
a lock body having
an engaging channel recessed in and formed in a top of the lock body;
a latching channel recessed in and formed in the top of the lock body and extending longitudinally toward a bottom of the lock body;
multiple wafer grooves formed in the lock body and arranged along a longitudinal direction at spaced intervals and located between the top and the bottom of the lock body, each of the wafer grooves having two opposite ends extending toward two opposite sides of the lock body respectively and communicating with the latching channel via one of the two opposite ends of the wafer groove; and
at least one key hole formed in the lock body and communicating with the wafer grooves;
a limiting wafer disposed in one of the wafer grooves that is closest to the top of the lock body and having a limiting hole formed through the limiting wafer and located in the latching channel;
multiple locking wafers respectively disposed in the other ones of the wafer grooves and being transversally slidable along the wafer grooves, each of the locking wafers having a locking hole formed through the locking wafer;
multiple restoring elastic members respectively disposed between the locking wafers and the lock body, and each of the restoring elastic members having two ends abutting against a corresponding one of the locking wafers and the lock body respectively; and
a shackle having
a bending segment being U-shaped and having two ends respectively defined as an engaging end and a connecting end, the engaging end selectively inserted into the engaging channel of the lock body; and
a latching segment extending from the connecting end of the bending segment, inserted into the latching channel of the lock body, extending through the limiting hole of the limiting wafer and the locking holes of the locking wafers, and having multiple engaging flanges arranged along the latching segment at spaced intervals; wherein
the limiting wafer is located between the connecting end of the bending segment and one of the engaging flanges that is closest to the connecting end of the bending segment; and
each of the locking wafers is pushed by the corresponding one of the restoring elastic members to move a hole edge of the locking hole of the locking wafer partially inside the latching channel to engage with a respective one of the engaging flanges of the latching segment via the respective one of the engaging flanges of the latching segment abutting against a bottom surface of the locking wafer.

2. The wafer padlock as claimed in claim 1, wherein
the lock body has one said key hole, and the said key hole is formed in the bottom of the lock body and longitudinally extends toward the top of the lock body;
the limiting wafer has a through hole formed through the limiting wafer and corresponding to said key hole in position; and
each of the locking wafers has an unlocking hole formed through the locking wafer and corresponding to said key hole in position, and the unlocking holes of the locking wafers are non-coaxially arranged.

3. The wafer padlock as claimed in claim 2, wherein
the lock body has a hollow lock housing and a lock core fixed in the lock housing;
the engaging channel is recessed in the lock housing;
the latching channel is formed in the lock housing and is formed between an inner surface of the lock housing and the lock core;
the multiple wafer grooves are formed in the lock core, are arranged at spaced intervals, and extend into the inner surface of the lock housing; and
the said key hole is formed through the lock housing and extends into the lock core.

4. The wafer padlock as claimed in claim 1, wherein
the lock body has multiple said key holes formed in one of the two opposite sides of the lock body that is away from the restoring elastic members; and
each of the locking wafers is aligned with multiple of or single one of the said key holes.

5. The wafer padlock as claimed in claim 4, wherein the locking wafers each have one respective length being different from one another.

6. The wafer padlock as claimed in claim 1, wherein
the lock body has a hollow lock housing and a lock core fixed in the lock housing;
the engaging channel is recessed in the lock housing;
the latching channel is formed in the lock housing and is formed between an inner surface of the lock housing and the lock core;
the multiple wafer grooves are formed in the lock core, are arranged at spaced intervals, and extend into the inner surface of the lock housing; and
the at least one key hole is formed through the lock housing.

7. The wafer padlock as claimed in claim 4, wherein
the lock body has a hollow lock housing and a lock core fixed in the lock housing;
the engaging channel is recessed in the lock housing;
the latching channel is formed in the lock housing and is formed between an inner surface of the lock housing and the lock core;
the multiple wafer grooves are formed in the lock core, are arranged at spaced intervals, and extend into the inner surface of the lock housing; and
the said multiple key holes are formed through the lock housing.

8. The wafer padlock as claimed in claim 5, wherein
the lock body has a hollow lock housing and a lock core fixed in the lock housing;
the engaging channel is recessed in the lock housing;
the latching channel is formed in the lock housing and is formed between an inner surface of the lock housing and the lock core;
the multiple wafer grooves are formed in the lock core, are arranged at spaced intervals, and extend into the inner surface of the lock housing; and
the said multiple key holes are formed through the lock housing.

9. The wafer padlock as claimed in claim 1, wherein a limiting elastic member is disposed between the limiting wafer and the lock body and has two ends respectively abutting against the lock body and the limiting wafer.

10. The wafer padlock as claimed in claim 2, wherein a limiting elastic member is disposed between the limiting wafer and the lock body and has two ends respectively abutting against the lock body and the limiting wafer.

11. The wafer padlock as claimed in claim 3, wherein a limiting elastic member is disposed between the limiting wafer and the lock body and has two ends respectively abutting against the lock body and the limiting wafer.

12. The wafer padlock as claimed in claim 4, wherein a limiting elastic member is disposed between the limiting wafer and the lock body and has two ends respectively abutting against the lock body and the limiting wafer.

13. The wafer padlock as claimed in claim 5, wherein a limiting elastic member is disposed between the limiting wafer and the lock body and has two ends respectively abutting against the lock body and the limiting wafer.

14. The wafer padlock as claimed in claim 6, wherein a limiting elastic member is disposed between the limiting wafer and the lock body and has two ends respectively abutting against the lock body and the limiting wafer.

15. The wafer padlock as claimed in claim 7, wherein a limiting elastic member is disposed between the limiting wafer and the lock body and has two ends respectively abutting against the lock body and the limiting wafer.

16. The wafer padlock as claimed in claim 8, wherein a limiting elastic member is disposed between the limiting wafer and the lock body and has two ends respectively abutting against the lock body and the limiting wafer.
